(19) United States
(12) Patent Application Publication
(10) Pub. No.: US 2002/0071732 A1
(43) Pub. Date: Jun. 13, 2002

(54) Corner cutting method and NC controller

(75) Inventors: Takahiro Funaki, Shizuoka-ken (JP); Tomoo Hayashi, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: TOSHIBA KIKAI KABUSHIKI KAISHA

(21) Appl. No.: 10/004,882

(22) Filed: Dec. 7, 2001

(30) Foreign Application Priority Data
Dec. 8, 2000 (JP) P2000-374673

(51) Int. Cl. B23C 3/26

(52) U.S. Cl. 409/132; 409/80

(57) ABSTRACT

An NC controller determines a subsequent point sequence position in each sampling by interpolation calculation with a section between a corner cutting starting point and a corner cutting end point as a machined section. The NC controller then internally calculates a spindle rotating angle in a coordinate position where an outer end of a cutting edge is positioned at the subsequent point sequence position. Based on the spindle rotating angle and the substantial diameter of the rotary tool, the NC controller internally calculates coordinate values of the spindle at the subsequent point sequence position. Based on the coordinate values of the spindle, the rotary tool and a workpiece are relatively shifted on a plane parallel to the bottom surface of the tool while the spindle rotation is controlled in synchronization with the shifting, thereby cutting the corner.

### BACKGROUND OF THE INVENTION

1. Field of the Invention

This invention relates to a method of cutting a corner as a recess or angle, and an NC (numerically controlling) controller therefor.

2. Description of the Related Art

For processing corners of a pocket such as a die cavity, conventionally employed is a cutting process by a rotary tool such as a cylindrical end mill, or an electrical discharge process by a bar electrode or wire electrode.

Now focused is a cutting process by an end mill that is inapplicable to a corner R processing of a pocket having a corner recessed with a smaller radius of curvature than the tool radius. Given a minimum radius of curvature of a recessed corner, the end mill to be employed for processing the corner needs a tool radius smaller than, and hence not exceeding at maximum, the given minimum radius. Still less, if the pocket is deep, the tool needs to have a long stem small in diameter, with an insufficient rigidity for the cutting to be proper. Yet, the end mill is inapplicable to processing an angled corner with a sharp angle, such as 90°, called “pin angle”.

Accordingly, for such a processing as to a pin angle or a pocket with deep recessed corners small of radius of curvature, the electrical discharge process is typically employed, which however is less efficient and dearer in cost than the cutting process, thus leading to a desideratum for a process to be complete with a single machine tool, without needing the electrical discharge as a different process, for a successful reduction of process lead time.

### SUMMARY OF THE INVENTION

This invention was made as a solution to such problems. It therefore is an object of the invention to provide a corner cutting method and an NC controller therefor, allowing for the cutting to be efficient in application to a corner processing such as of a pocket with deep recessed corners small of radius of curvature (minute R), or of an angled corner with a sharp angle, such as 90°, called “pin angle”.

According to an aspect of this invention, there is provided a corner cutting method in which a rotary tool having a cutting edge at least on a bottom surface thereof and on an outer periphery thereof is used, the rotary tool and a workpiece are relatively shifted on a plane parallel to the bottom surface of the tool so that an outer end of the cutting edge of the rotary tool rotated by a spindle creates a shifting path meeting a desirable shape of a corner to be machined, and the rotary tool is shifted while cutting in an axis direction of the rotary tool, the method comprising the steps of: inputting information on coordinate values and a direction and an angle of a corner to be machined and information on the rotary tool, to an NC controller; internally calculating coordinate values at a corner cutting starting point where the outer end of the cutting edge is positioned, and a spindle rotating angle in this position, and coordinate values of a corner cutting end point, based on the input information; internally calculating a spindle rotating angle at a coordinate position where the outer end of the cutting edge is positioned at a subsequent point sequence position in each sampling, the subsequent point sequence position being obtained by an interpolation calculation, letting a section between the corner cutting starting point and the corner cutting end point be a section to be machined; internally calculating coordinate values of the spindle at the subsequent point sequence position based on the spindle rotating angle and a substantial diameter of the rotary tool; and relatively shifting the rotary tool and the workpiece based on the coordinate values of the spindle on a plane parallel to the bottom surface of the tool while controlling the spindle rotation in synchronization with the shifting.

The above method thus allows effective machining of a deep pocket with corners of a small radius of curvature or a corner of 90 degrees or less while maintaining sufficient rigidity of the tool.

According to another aspect of this invention, the interpolation comprises one of a linear interpolation, a circular interpolation, a free-form curve interpolation, and an arbitrary combination thereof.

Thus the interpolation may be any existing interpolation.

According to yet another aspect of this invention, there is provided an NC controller for implementing a corner cutting method according to either of the above aspects, comprising: an analyzer for analyzing a machining program comprising commands for implementing the corner cutting method, the commands being set as one code of G function.

Thus the method does not depend on a macro program with a divided point-shifting block sequence made as another program, allowing efficient machining in a smooth cutting-edge path at a high cutting speed.

### BRIEF DESCRIPTION OF THE DRAWINGS

The above and further objects and novel features of this invention will more fully appear from the following detailed description when the same is read in conjunction with the accompanying drawings, in which:

FIG. 1 is a perspective illustration of a machine tool for implementing a corner cutting method embodying this invention;

FIG. 2 is a perspective view of a rotary tool to be used in the embodying method, as it is in an inverted position with a bottom oriented upward,

FIG. 3 is a bottom view of the rotary tool;

FIG. 4 is a plan as an illustration of a corner cutting in the embodying method;

FIGS. 5A to 5C are plans illustrating a process of cutting a 90-degree corner in the embodying method;

FIG. 6 is a graph plotting a tool moving path in the cutting of 90-degree corner;

FIG. 7 is an illustration showing a direction and an angle of a corner;

FIGS. 8A to 8C illustrate various rotary tools applicable to the embodying method;

FIG. 9 is an illustration of a corner cutting method according to corner cutting code G180 (G181);

FIG. 10 is a functional block diagram of an NC controller according to an embodiment of this invention;

FIG. 11 is a flow chart of a corner cutting process by the NC controller;

FIG. 12 is an illustration of a corner cutting method according to another embodiment of this invention;

FIG. 13 illustrates another rotary tool applicable to this invention; and

FIG. 14 illustrates another rotary tool applicable this invention.

### DETAILED DESCRIPTION OF THE PREFERRED EMBODIMENTS

There will be detailed below the preferred embodiments of this invention with reference to the accompanying drawings. Like members are designated by like reference characters.

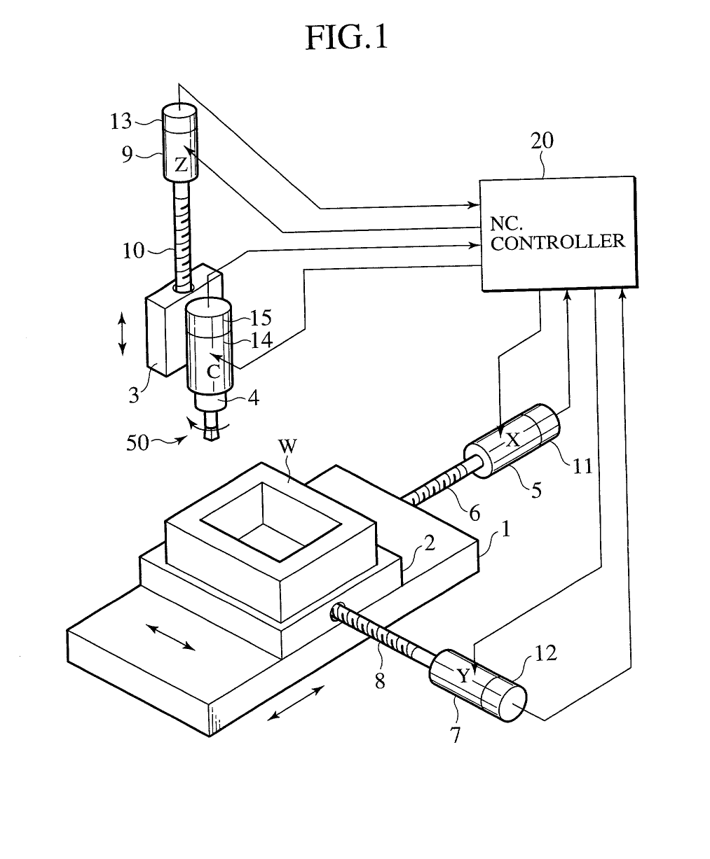

FIG. 1 shows a machine tool for use in a corner cutting method according to this invention. The machine tool has an X-axis table 1 movable in the X-axis direction, a Y-axis table 2 movable in the Y-axis direction mounted on the X-axis table, a headstock 3 movable in the Z-axis direction and a spindle 4 attached to the headstock 3. A workpiece W is set on the Y-axis table.

The X-axis table 1 is shifted in the X-axis direction by an X-axis feed mechanism 6 driven by an X-axis servomotor 5. The Y-axis table 2 is shifted in the Y-axis direction by a Y-axis feed mechanism 8 driven by a Y-axis servomotor 7. The headstock 3 is shifted in the Z-axis direction by a Z-axis feed mechanism 10 driven by a Z-axis servomotor 9. Rotary encoders 11, 12 and 13 for position detection are mounted to the X-, Y- and Z-axis servomotors 5, 7 and 9, respectively.

The spindle 4 is driven by a spindle motor 14. A rotary encoder 15 mounted to the spindle motor 14 detects an angle of rotation (C-axis angle) of the spindle 4. A rotary tool 50 is attached to the spindle 4.

The machine tool may be of a numerical control type. An NC controller 20 is input position information and C-axis angle information from the rotary encoders 11, 12, 13 and 15 of the respective axes, and controls the rotational driving of the spindle 4 by the spindle motor 14 and the driving of the servomotors 5, 7 and 9 of the respective axes.

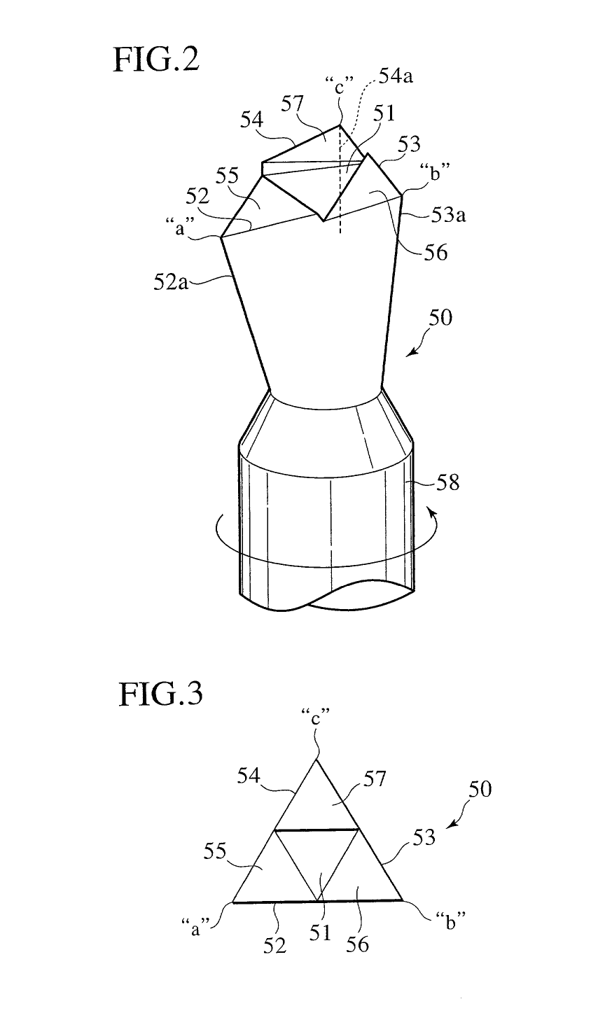

FIGS. 2 and 3 show a rotary tool to be used in the embodiment according to the this invention. In FIG. 2, the rotary tool is seen in an inverted position with a bottom oriented upward, and FIG. 3 is a bottom view of the rotary tool.

The rotary tool used in the embodying method has a polygonal bottom surface such as a triangular, quadrangular or pentagonal surface, having at least one cutting edge at the bottom and one on the outer periphery. A rotary tool 50 as shown in FIGS. 2 and 3 has a regular triangular bottom surface 51. Each side of the triangular bottom 51 has a cutting edge 52, 53 or 54 extending half the length of the side to the vertex “a”, “b” or “c” (outer ends of the cutting edge) of the triangle. Clearance angles (flanks 55, 56 and 57) are provided rearward of the cutting edges. The cutting edges 52, 53 and 54 also extend the length of the peripheral ridges extending from the vertices “a”, “b” and “c” in the axis direction.

The rotary tool 50 also has a trunk 58 in a cylindrical shape extending along the axis line passing the internal center of the regular triangular bottom surface 51. The trunk 58 is held by a chuck (not shown) of the spindle 4 and is driven to rotate in the counterclockwise direction around the axis line in FIGS. 2 and 3.

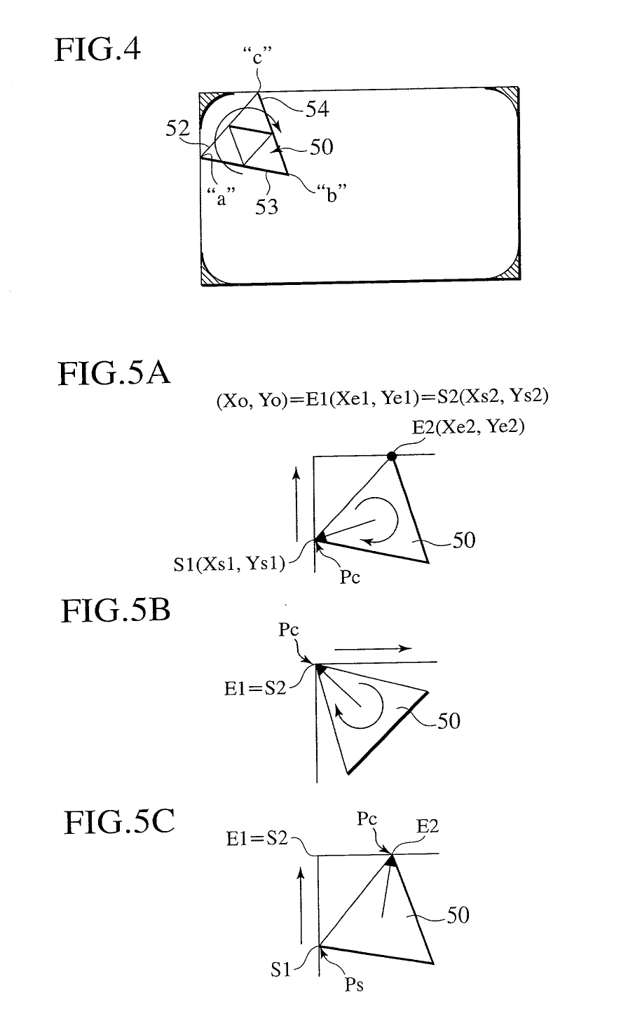

FIG. 4 shows the rotary tool 50 used for cutting off remaining parts (hatched) of corners (internal angles) of a workpiece W while being shifted along the corner sides. The rotary tool 50 is also rotated by the spindle 4 in correspondence with the shifting.

In this corner cutting method, the NC controller 20 is given vertex coordinate values (Xo, Yo) as shown in FIGS. 5A to 5C and information on a direction and an angle of a corner to be machined, and information on the rotary tool 50. Based on the information, the NC controller 20 internally calculates coordinate values of corner cutting starting points S1, S2, i.e., (Xs1, Ys1), (Xs2, Ys2), at which any of the vertices (outer ends) “a”, “b” and “c” of the cutting edges 52, 53 and 54 is positioned at Pc, spindle rotating angles in the coordinates, and coordinate values of corner cutting end points E1, E2, i.e., (Xe1, Ye1), (Xe2, Ye2). Then, a subsequent point sequence position in each sampling is determined by linear interpolation calculation with each of the interval between the starting point S1 and the end point E1 and the interval between the starting point S2 and the end point E2 as a machined section. The NC controller 20 internally calculates a spindle rotating angle at a coordinate position where any of the vertices (outer ends) of the cutting edges 52, 53 and 54 is positioned at the determined subsequent position Ps. From this spindle rotating angle and the substantial diameter of the rotary tool 50, the NC controller 20 internally calculates coordinate values of the spindle 4 at the determined subsequent position. Based on the coordinate values of the spindle 4, the X-axis table 1 and the Y-axis table 2 are shifted in the respective axis directions so as to relatively shift the rotary tool 50 and the workpiece W on a plane parallel to the bottom surface of the tool. In synchronization with the shifting, the rotation of the spindle 4 is controlled to machine the corner.

The interpolation is not limited to the linear interpolation, and may be circular interpolation, free-form curve interpolation, or any combination thereof. Circular interpolation is used to machine round corners.

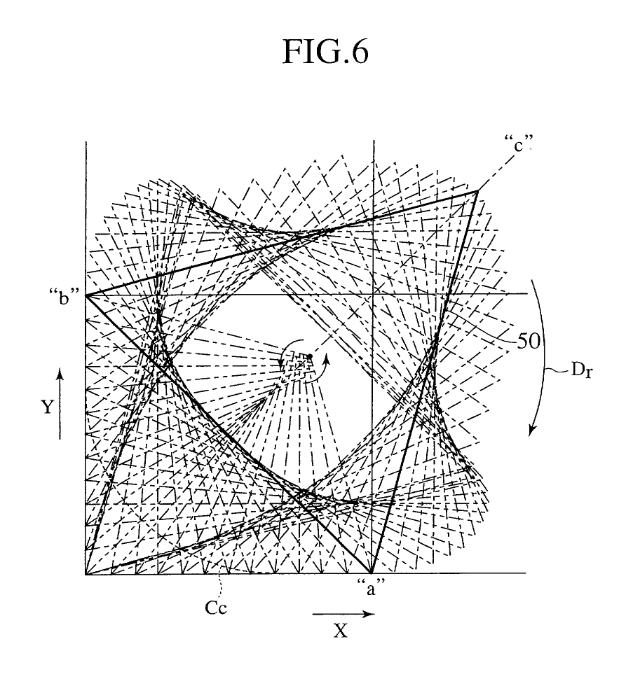

The above-described corner cutting method allows cutting a round corner of a small radius of curvature with a tool of a radius greater than that of the round corner. Further the method enables cutting of a right angle, which is larger than the internal angle of the polygonal bottom surface 51. The rotary tool 50 with the regular triangle bottom surface has an internal angle of 60 degrees, so that the tool can cut a right angle as shown in FIG. 6. FIG. 6 shows a moving path of the tool when machining a right angle. In the figure, reference sign Cc denotes the shape of the corner before machining. The area surrounded by the imaginary line Cc, the X-coordinate axis line and the Y-coordinate axis line is to be removed by the machining. Designated by reference character Dr is the direction of tool rotation.

In this example, the rotary tool 50 rotates 120 degrees is a cycle. Upon one cycle, the subsequent edge is positioned at a starting point S1. Thus repetition of the above machining cycle enables continuous corner cutting. Shifting the rotary tool 50 cutting in the depth direction in a cycle or upon completion of cycles allows the machining of a deep corner.

The NC controller 20 analyzes a machining program consisting of commands for implementing the corner cutting method, set as a code of G function, G180 (CW direction), G181 (CCW direction), for example, thereby implementing the method. An exemplary format of G180 (G181) is as follows:

G180 (G181) Xo_Yo_A_B_Zo_Z_Q_P_K_(:r)F_, in which:

Xo, Yo are corner vertex coordinate values (ABS/INS);

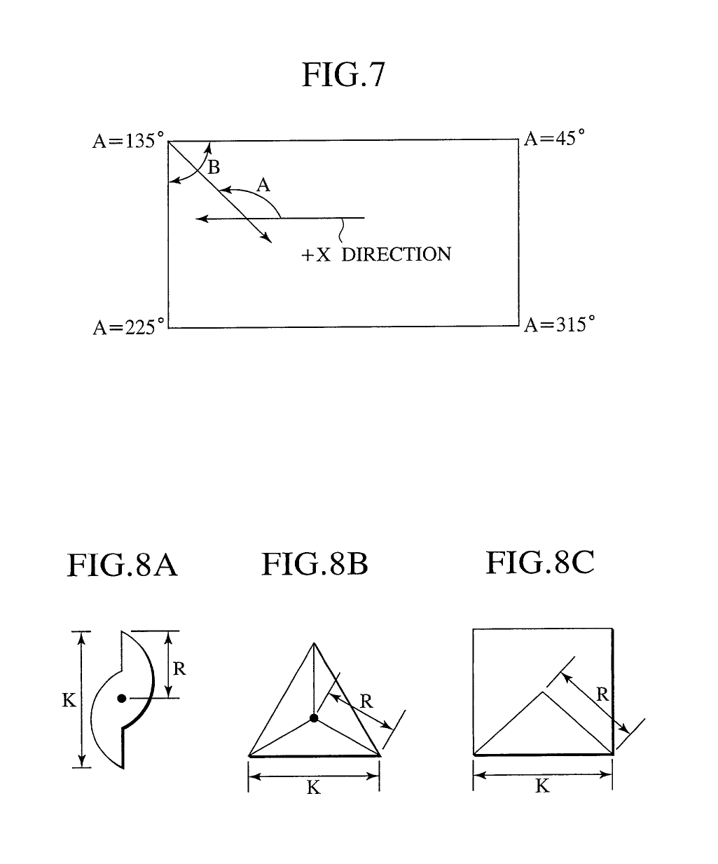

A is a corner direction (+an angle between an X-axis direction and a corner position) (See FIG. 7);

B is a corner angle (See FIG. 7);

Zo is a clearance point in a Z-axis direction (ABS/INS);

Z is a depth end point in the Z-axis direction (ABS/INS);

Q is a cutting amount in a depth direction;

P is a shape of a cutting tool (2: two-vertices tool; 3: triangle tool; 4: quadrangle tool) (See FIGS. 8A to 8C);

K is the length of one side of the cutting tool (See FIGS. 8A to 8C);

:r is a round of a corner (no round when not specified); and

F is an edge cutting speed (when specified, subsequent F is the specified one).

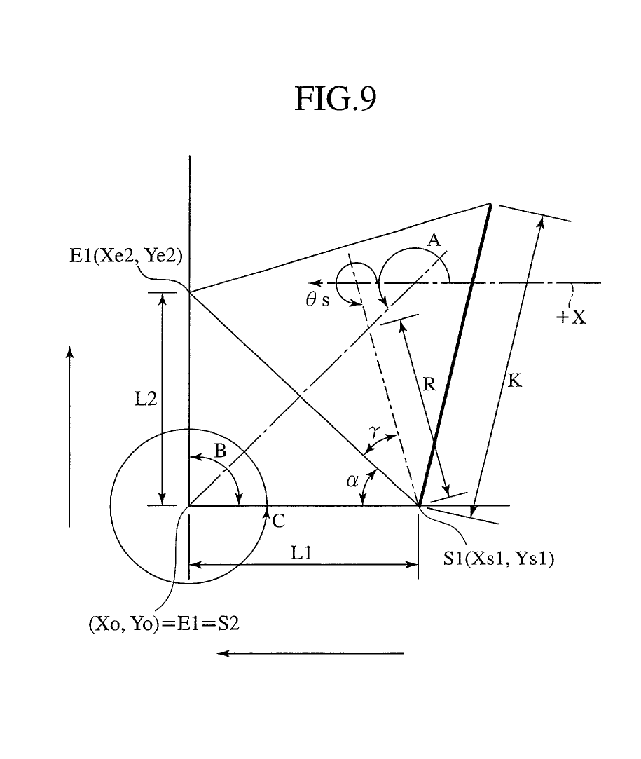

Now, with reference to FIG. 9, the corner cutting based on the corner cutting code G180 (G181) will be described.

The substantial radius R of the cutting tool 50 is expressed as R=K/(2 cos γ) derived from K=2R cos γ. γ depends on P specified, and is 0 degree in a two-vertices tool, 30 degrees in a triangular tool, and 45 degrees in a quadrangular tool.

Here, corner angle B is not less than 90 degrees, and the cutting edge is shifted from S1 through (Xo, Yo) to E2.

α=(180−B)/2

C=A+180−(B/2)

L1 cos α=K/2

Hence, L1=K/(2 cos α)

L2 cos α=K/2

Hence, L2=K/(2 cos α)

The starting point is indicated as (Xs1, Ys1), the corner vertex coordinates (Xo, Yo), and the end point (Xe2, Ye2).

Xs1=Xo+L1 cos C

=Xo+K cos C/2(cos α)

Ys1=Yo+L1 sin C

=Yo+K sin C/(2 cos α)

Xe2=Xo+L2 cos(B+C)

=Xo+K cos(B+C)/2(cos α)

Ys1=Yo+L2 sin(B+C)

=Yo+K sin(B+C)/(2 cos α)

The spindle angle at (Xo, Yo) is expressed as θo. The spindle angle at the starting point (Xs1, Ys1) is expressed by θo+θe. θe is (90−γ), and is 90 degrees in the two-vertices tool, 60 degrees in the triangular tool, and 45 degrees in the quadrangular tool.

The spindle angle θ new when the cutting edge is shifted by Llead on a path from the starting point is expressed with the remaining shifting amount Ldist to the end point.

Ldist=L1(or L2)−Llead

θnew=A+(Ldist/L1(or L2))G

Initially, Ldist=L1(or L2). G is the spindle rotating angle from the starting point to the corner vertex.

The spindle rotating angle Δθ in each sampling is expressed as:

Δθ=θnew−θold

θ old is a spindle rotating angle one sampling before.

Coordinates (Xt, Yt) of a tool edge shifting on the path is expressed as follows:

I. From the starting point S1 to the corner vertex position (Xo, Yo)

Xt=Xo+Ldist·cos C

Yt=Yo+Ldist·sin C

II. From (Xo, Yo) to the end point E2

Xt=Xo+Ldist·cos(B+C)

Yt=Yo+Ldist·sin(B+C)

The spindle center coordinates (Xsp, Ysp) is expressed as follows:

Xsp=Xt+R cos θnew

Ysp=Yt+R sin θnew

Spindle position distributing amounts ΔXsp, ΔYsp during one sampling are expressed as follows:

ΔXsp=R cos θnew−R cos θold

ΔYsp=R sin θnew−R sin θold

The spindle rotating angle Δθ and the spindle position distributing amounts ΔXsp, ΔYsp are specified every sampling to the servomotors 5, 7 and the spindle motor 14 for corner cutting.

The machining may be implemented by a macro program with a divided point-shifting block sequence made as another program. However, the machining based on the corner cutting code G180 (G181) does not depend on the number of blocks divided, allowing more effective cutting in a smoother cutting edge path at a higher speed as compared with the machining by such a macro program.

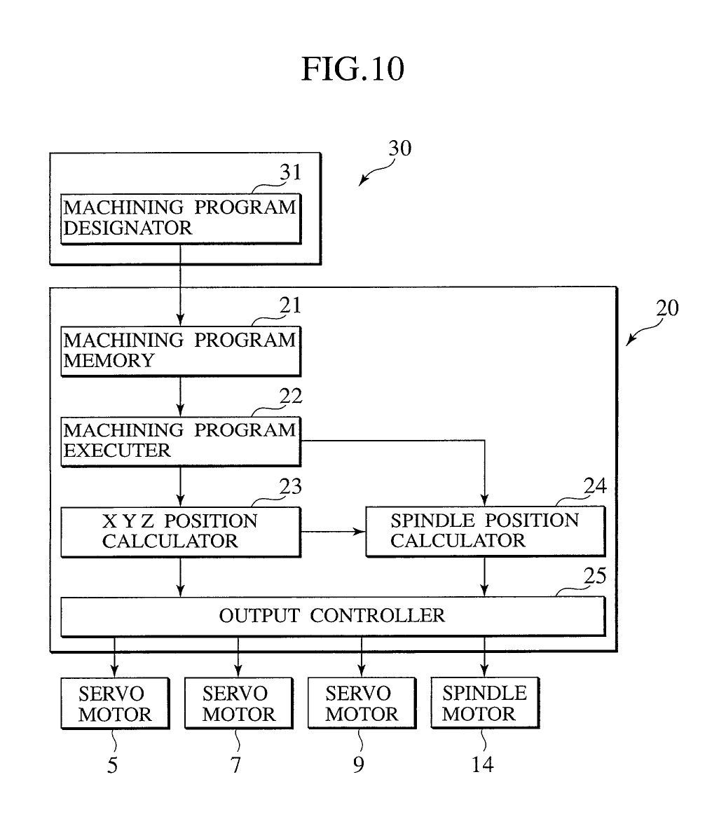

FIG. 10 shows the architecture of the NC controller 20. The NC controller 20 is input a machining program by a machining program specifying section 31 of an input device 30, and stores the machining program in a machining program memory 21. The NC controller 20 includes a machining program executing section 22, XYZ position calculating section 23, and spindle position calculating section 24 implemented by a computer.

The executing section 22 reads the machining program from the memory 21, and analyzes the program to execute. The XYZ position calculating section 23 calculates control target values of the X, Y and Z axes based on the data from the executing section 22. The spindle position calculating section 24 calculates a control target value of the spindle position (spindle rotating angle) based on data from the executing section 22 and data from the XYZ position calculating section 23. These control target values are outputted to an output controller 25. The output controller 25 controls the driving of the servomotors 5, 7 and 9 and the spindle motor 14 based on the control target values.

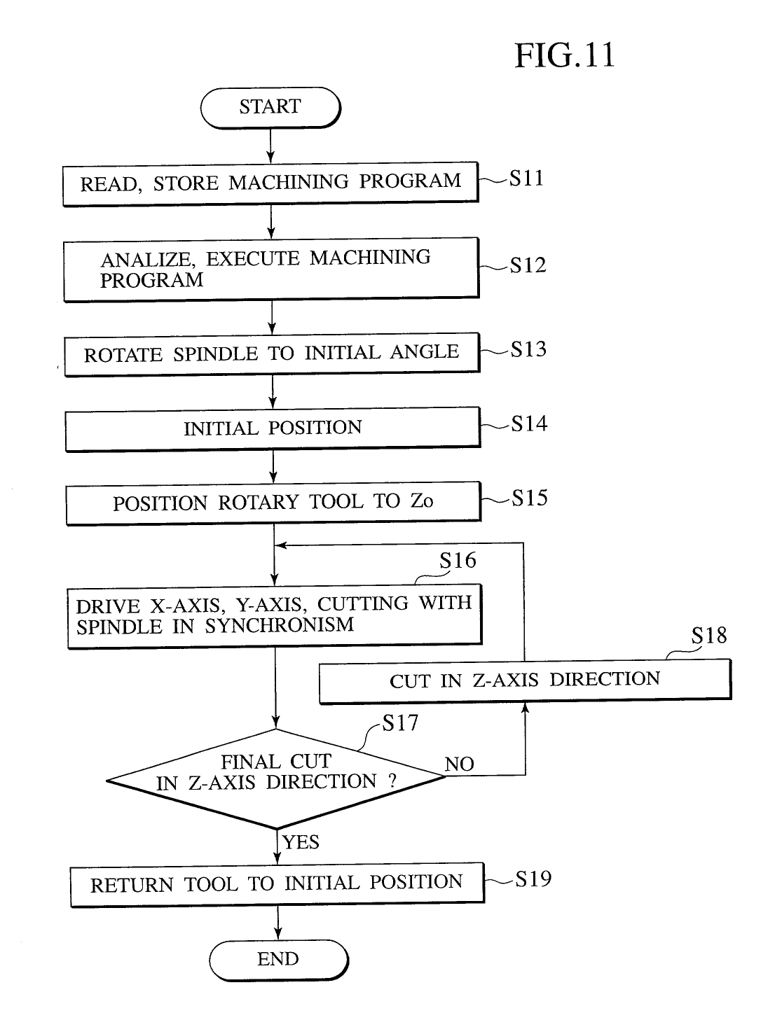

Now, the process of corner cutting with the NC controller 20 will be described with reference to a flow chart shown in FIGS. 11.

The first step is to read the machining program from the machining program specifying section 31 to store it in the machining program memory 21 (step S11). Then in the machining program executing section 22, the program is analyzed and executed, and control commands required for desired machining are outputted to the XYZ position calculating section 23 (step S12).

Next, based on the control commands from the executing section 22, the spindle 4 is rotated to a machining starting angle (initial angle) (step S13), and the rotary tool 50 is positioned at the starting position (initial position) (step S14). Then, based on the control commands from the executing section 22, the rotary tool 50 is positioned at Zo point (clearance point in the Z-axis direction) (step S15).

Next, based on the control commands from the executing section 22, machining is performed, synchronizing the shifting of the workpiece W in the X-, Y-axis directions and the rotation of the spindle 4 (step S16). It is determined whether the Z-axis direction reaches the final cutting position (hole bottom position) (step S17). When the decision is NO, the cutting in the Z-axis direction is carried out (step S18). When YES, the rotary tool 50 is returned to the initial position (step S19).

Instead of shifting the workpiece W in the X- and Y-axis directions, the rotary tool 50, that is, the headstock 3 may be shifted in the X- and Y-axis directions.

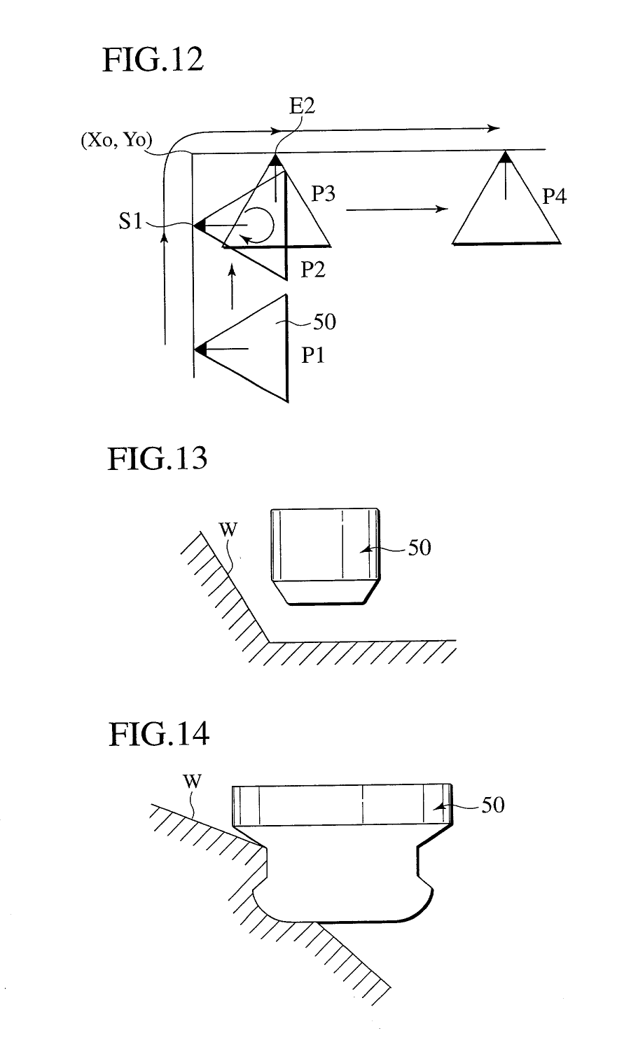

The above-described machining with the triangular tool is limited to the corner from the starting point S1 to the end point E2. In some cases, however, a wider area extending before the starting point S1 and after the end point E2 is to be machined as shown in FIG. 12. In these cases, the rotary tool 50 is shifted while cutting without rotation of the spindle 4 in a section from P1 to P2. In a section from P2 to P3, the above-described corner cutting is performed with the shifting of the rotary tool 50 and the rotation of the spindle 4, synchronized to one another. In a section from P3 to P4, the rotary tool 50 is shifted while cutting without rotation of the spindle 4. Thus the wider area extending before the starting point S1 and after the end point E2 can be continuously machined.

Cutting edge angles with respect to the workpiece in the sections from P1 to P2 and from P3 to P4 may be arbitrarily set in accordance with the shape of the tool cutting edge, the material of the workpiece, and the like. The sections from P1 to P2 and from P3 to P4 are not limited to linear ones. Any path may be specified as desired.

When the front shape of the rotary tool 50 is tapered as shown in FIG. 13, an inclined corner surface can be machined. When the front end of the rotary tool 50 is shaped as desired as shown in FIG. 14, various shapes of machined surfaces are obtained.

While preferred embodiments of the present invention have been described using specific terms, such description is for illustrative purposes, and it is to be understood that changes and variations may be made without departing from the spirit or scope of the following claims.

What is claimed is:

1. A corner cutting method in which a rotary tool having a cutting edge at least on a bottom surface thereof and on an outer periphery thereof is used, the rotary tool and a workpiece are relatively shifted on a plane parallel to the bottom surface of the tool so that an outer end of the cutting edge of the rotary tool rotated by a spindle creates a shifting path meeting a desirable shape of a corner to be machined, and the rotary tool is shifted while cutting in an axis direction of the rotary tool, the method comprising the steps of:
inputting information on coordinate values and a direction and an angle of a corner to be machined and information on the rotary tool, to an NC controller;
internally calculating coordinate values at a corner cutting starting point where the outer end of the cutting edge is positioned, and a spindle rotating angle in this position, and coordinate values of a corner cutting end point, based on the input information;
internally calculating a spindle rotating angle at a coordinate position where the outer end of the cutting edge is positioned at a subsequent point sequence position in each sampling, the subsequent point sequence position being obtained by an interpolation calculation, letting a section between the corner cutting starting point and the corner cutting end point be a section to be machined;
internally calculating coordinate values of the spindle at the subsequent point sequence position based on the spindle rotating angle and a substantial diameter of the rotary tool; and
relatively shifting the rotary tool and the workpiece based on the coordinate values of the spindle on a plane parallel to the bottom surface of the tool while controlling the spindle rotation in synchronization with the shifting.

2. A corner cutting method according to claim 1, wherein the interpolation comprises one of a linear interpolation, a circular interpolation, a free-form curve interpolation, and an arbitrary combination thereof.

3. An NC controller for implementing the corner cutting method according to claim 1 or 2, comprising:
an analyzer for analyzing a machining program comprising commands for implementing the corner cutting method, the commands being set as one code of G function.
